(19) United States
(12) Patent Application Publication
(10) Pub. No.: US 2008/0133260 A1
(43) Pub. Date: Jun. 5, 2008

(54) INFORMATION COMMUNICATION SYSTEM, INFORMATION COMMUNICATION METHOD, AND STORAGE MEDIUM

(75) Inventors: Masayuki FUKUI, Kawasaki (JP); Tatsuro MATSUMOTO, Kawasaki (JP); Ai YANO, Kawasaki (JP); Kazuo SASAKI, Kawasaki (JP); Eiichi TAKAHASHI, Kawasaki (JP); Masahiro HARA, Kawasaki (JP); Yutaka IWAYAMA, Kawasaki (JP); Youji KOHDA, Kawasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/949,448

(22) Filed: Dec. 3, 2007

(30) Foreign Application Priority Data
Dec. 1, 2006 (JP) 2006-325988

(51) Int. Cl. G06Q 99/00; G01C 21/00

(52) U.S. Cl. 705/1; 701/300

(57) ABSTRACT

An information communication system having a location information acquisition part and storage part which acquires and stores respectively, mobile terminal location information indicating a location of a mobile terminal; a location information updating part which updates mobile terminal location information stored in the location information storage part; a facility information storage part storing facility information identifying a facility and facility location information; a facility information extraction part which extracts facility information indicating the facility in the facility information storage part; a facility stay determination part which determines whether a user of the mobile terminal is staying at the facility indicated by the facility information extracted by the facility information extraction part and an inquiry part which outputs query information for inquiring about an evaluation of the facility to the user of the mobile terminal when it is determined that the user of the mobile terminal is staying at the facility.

### CROSS-REFERENCE TO RELATED APPLICATIONS

This application is based upon and claims the benefit of priority from the prior Japanese Patent Application No. 2006-325988, filed on Dec. 1, 2006, the entire content of which is incorporated herein by reference.

### TECHNICAL FIELD

The present invention relates to an information communication system, an information communication method, and a storage medium, and more specifically, to an information communication system, an information communication method, and a program which output query information for inquiring for an evaluation of a facility such as a store, a parking facility or a gas station to a user of a portable terminal or a mobile terminal such as an automotive navigation system.

### SUMMARY OF THE INVENTION

In recent years, evaluation information that represents an evaluation of a facility is posted on an on-line bulletin board, a personal website, a blog, or the like by a user that has visited the facility. In addition, along with the recent rapid diffusion of portable terminals (mobile terminals) equipped with e-mail functions, evaluation information is being sent and received via e-mail between users. From a corporate perspective, such evaluation information is exploitable by marketing businesses that transmit such information as advertising information on facilities. Furthermore, from a personal perspective, such information may be used for deciding whether the facilities should be visited.

An object of the present invention is to provide an information communication system, an information communication method, and a storage medium which outputs query information for inquiring for an evaluation of a facility to a user of a mobile terminal in the event that the user is staying at the facility.

In order to achieve the above object, an information communication system according to the present invention includes: a location information acquisition part which acquires mobile terminal location information indicating a present location of a mobile terminal; a location information storage part which stores the mobile terminal location information; a location information updating part which updates the mobile terminal location information stored in the location information storage part with mobile terminal location information acquired by the location information acquisition part; a facility information storage part which stores facility information identifying a facility and facility location information indicating a location range of the facility; a facility information extraction part which, in the event that the present location of a mobile terminal indicated by the mobile terminal location information indicates a location within the location range of a facility indicated by the facility location information, extracts facility information indicating the facility from the facility information storage part; a facility stay determination part which determines whether a user of the mobile terminal is staying at the facility indicated by the facility information extracted by the facility information extraction part based on information on the mobile terminal or information on a mobile unit to which the mobile terminal is mounted; and an inquiry part which outputs query information for inquiring for an evaluation of the facility to the user of the mobile terminal when the facility stay determination part determines that the user of the mobile terminal is staying at the facility.

### BRIEF DESCRIPTION OF THE DRAWINGS

FIG. 1 is a block diagram showing a schematic configuration of an evaluation information distribution system according to a first embodiment of the present invention;

FIG. 2 is a diagram showing an example of a data structure of a location information management table in an evaluation information management apparatus of the evaluation information distribution system described above;

FIG. 3 is a diagram showing an example of a data structure of a facility information management table of the evaluation information management apparatus described above;

FIG. 4 is a diagram showing an example of a data structure of a stay determination time management table of the evaluation information management apparatus described above;

FIG. 5 is a diagram showing an example of a data structure of a query information management table of the evaluation information management apparatus described above;

FIG. 6 is a diagram showing an example of a data structure of a user information management table of the evaluation information management apparatus described above;

FIG. 7 is a schematic diagram showing an example of query information to be displayed on a display section of a mobile terminal of the evaluation information distribution system described above;

FIG. 8 is a schematic diagram showing an example of query information to be displayed on the display section described above;

FIG. 9 is a schematic diagram showing an example of query information to be displayed on the display section described above;

FIG. 10 is a schematic diagram showing an example of query information to be displayed on the display section described above;

FIG. 11 is a diagram showing an example of a data structure of an evaluation information management table of the evaluation information management apparatus described above;

FIG. 12 is a flowchart showing an outline of processing for transmitting query information from the evaluation information management apparatus to the mobile terminal described above;

FIG. 13 is a flowchart showing an outline of processing for transmitting evaluation information from the mobile terminal to the evaluation information management apparatus described above;

FIG. 14 is a flowchart showing an outline of processing for distributing evaluation information from the evaluation information management apparatus to the mobile terminal described above;

FIG. 15 is a flowchart showing an outline of processing for notifying user information from the evaluation information management apparatus described above to a facility computer;

FIG. 16 is a block diagram showing a schematic configuration of an evaluation information distribution system according to a second embodiment of the present invention;

FIG. 17 is a diagram showing an example of a data structure of a location information management table in a mobile terminal of the evaluation information distribution system described above;

FIG. 18 is a diagram showing an example of a data structure of a facility information management table of the mobile terminal described above;

FIG. 19 is a block diagram showing a schematic configuration of an evaluation information management apparatus of the evaluation information distribution system described above;

FIG. 20 is a diagram showing an example of a data structure of an evaluation information management table of the evaluation information management apparatus described above; and

FIG. 21 is a flowchart showing an outline of processing for announcing the user of the mobile terminal described above of query information.

### DETAILED DESCRIPTION OF INVENTION

### First Embodiment

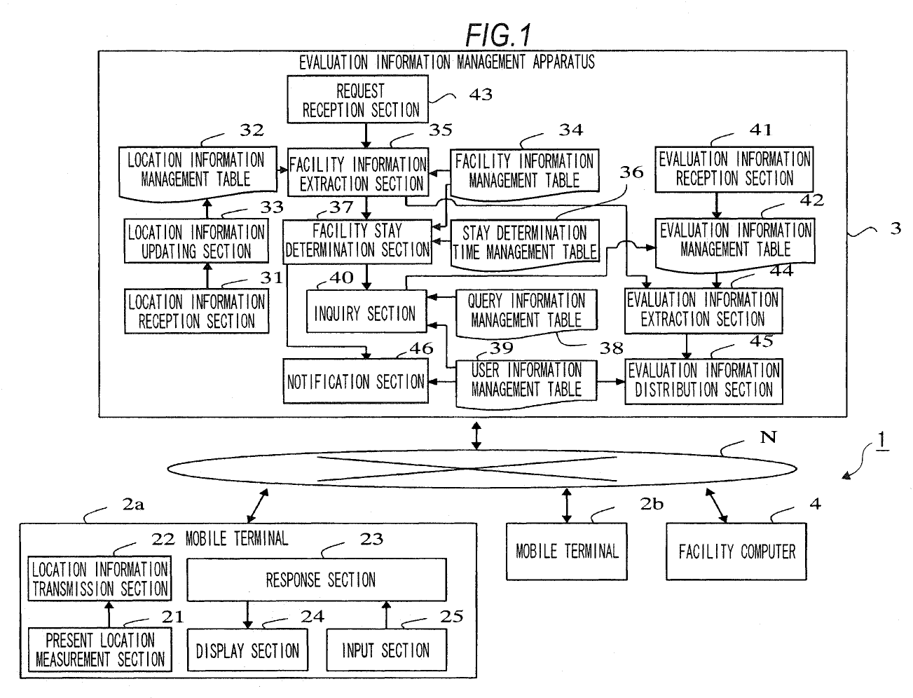

FIG. 1 is a block diagram showing a schematic configuration of an evaluation information distribution system 1 according to the present embodiment. More specifically, the evaluation information distribution system 1 according to the present embodiment includes mobile terminals 2a, 2b, an evaluation information management apparatus (information communication system) 3, and a facility computer 4. The mobile terminals 2a, 2b, the evaluation information management apparatus 3 and the facility computer 4 are connected to each other via the Internet N. The mobile terminals 2a, 2b are, for instance, portable terminals such as a mobile phone, a PHS (Personal Handyphone System) or a PDA (Personal Digital Assistant), or a terminal device such as an automotive navigation system or on-vehicle equipment provided on a mobile unit such as a vehicle. The evaluation information management apparatus 3 is an apparatus that manages evaluation information generated by the mobile terminals 2a, 2b and which indicates an evaluation of a facility. The facility computer 4 is a computer installed at a facility. In this case, “facility” includes facilities such as stores, parking facilities and gas stations. However, “facility” may also encompass various other facilities such as hospitals, movie theaters, libraries, accommodations, golf courses, ski resorts, amusement parks, art museums, and museums.

Although FIG. 1 shows two mobile terminals 2a and 2b, and one each of the evaluation information management apparatus 3 and the facility computer 4 for ease of description, the respective numbers of the mobile terminals 2a, 2b, the evaluation information management apparatus 3 and the facility computer 4 which comprise the evaluation information distribution system 1 are arbitrary. In addition, other terminal devices, web servers, proxy servers, DNS (Domain Name System) servers, DHCP (Dynamic Host Configuration Protocol) servers, and the like may exist on the evaluation information distribution system 1.

Hereinafter, when describing parts having the same functions, lower case letters for distinguishing among parts having the same functions such as, for example, in the case of the mobile terminal 2a, will only be attached for descriptive purposes when such distinctions are necessary. When there is no need to distinguish or when a generic designation is used, descriptions will be given without attaching lower case letters such as, for example, in the case of the mobile terminal 2.

### (Configuration of Mobile Terminal)

The mobile terminal 2a includes a present location measurement section 21, a location information transmission section 22, a response section 23, a display section 24 and an input section 25. The configuration of the mobile terminal 2b is similar to that of the mobile terminal 2a.

The present location measurement section 21 measures the present location of the mobile terminal 2a. More specifically, the present location measurement section 21 is equipped with, for instance, a GPS (Global Positioning System) function. The present location measurement section 21 receives radio waves transmitted from a plurality of geodetic satellites (GPS satellites), and based on the relative time difference among the received radio waves, measures the present location of the mobile terminal 2a. Whenever the present location of the mobile terminal 2a changes, the present location measurement section 21 outputs mobile terminal location information indicating the present location of the mobile terminal 2a to the location information transmission section 22. Mobile terminal location information includes a mobile terminal ID for uniquely identifying the mobile terminal 2a, as well as latitude and longitude information indicating the present location of the mobile terminal 2a. Although an example in which the present location measurement section 21 is equipped with a GPS function has been described above, the present location measurement section 21 is not limited to this arrangement. More specifically, the present location measurement section 21 may be arranged to measure the present location of the mobile terminal 2a by receiving location information from a nearby mobile phone base station, a wireless LAN access point or the like with which the mobile terminal 2a is able to communicate. In addition, the present location measurement section 21 may be arranged to measure the present location of the mobile terminal 2a by receiving location information from a road sign, an address sign or the like. To put it briefly, various arbitrary methods may be adopted as long as the present location measurement section 21 is able to measure the present location of the mobile terminal 2a.

The location information transmission section 22 transmits mobile terminal location information indicating the present location of the mobile terminal 2a to the evaluation information management apparatus 3 every time mobile terminal location information is output from the present location measurement section 21. More specifically, the location information transmission section 22 transmits mobile terminal location information to the evaluation information management apparatus 3 in real time. The location information transmission section 22 may be alternatively arranged to transmit mobile terminal location information to the evaluation information management apparatus 3 every time the mobile terminal 2a moves a given distance or at given time intervals.

The response section 23 receives query information for inquiring for an evaluation of a facility which is transmitted from the evaluation information management apparatus 3. The response section 23 outputs the received query information to the display section 24. After the response section 23 receives the query information, when the user of the mobile terminal 2a inputs a reply to the query information (inquiry) using the input section 25, the response section 23 transmits evaluation information obtained as a reply to the query information and which indicates an evaluation of a facility to the evaluation information management apparatus 3. In addition, when the user of the mobile terminal 2a issues a request for acquiring evaluation information using the input section 25, the response section 23 transmits request information to the evaluation information management apparatus 3. After the response section 23 transmits the request information, the response section 23 receives evaluation information corresponding to the transmitted request information from the evaluation information management apparatus 3. The response section 23 outputs the received evaluation information to the display section 24.

The display section 24 displays query information outputted from the response section 23. In addition, the display section 24 displays evaluation information outputted from the response section 23. The display section 24 is constituted by a liquid crystal display, an organic EL display, a plasma display, a CRT display, or the like. An example of query information displayed on the display section 24 will be described later.

The input section 25 allows the user of the mobile terminal 2a to input a reply to the query information displayed on the display section 24. In addition, the input section 25 allows the user of the mobile terminal 2a to issue a request for acquiring evaluation information. The input section 25 is constituted by an arbitrary input device such as a keyboard, a mouse, a numeric keypad, a tablet, a touch panel, or a voice recognition device.

When the mobile terminal 2a is a terminal device such as an automotive navigation system or on-vehicle equipment provided on a mobile unit such as a vehicle, the input section 25 is preferably a voice recognition device. This enables the user to input a reply to query information in a so-called eyes-free (without the use of the eyes) and hands-free (without using the hands) manner, even when the user is driving the mobile unit.

Incidentally, the mobile terminal 2a described above may also be realized by installing a program in an arbitrary computer such as a personal computer. More specifically, the present location measurement section 21, the location information transmission section 22, the response section 23, the display section 24 and the input section 25 described above are realized when a CPU of the computer operates in accordance with a program that realizes these functions. Therefore, a program for realizing the functions of the present location measurement section 21, the location information transmission section 22, the response section 23, the display section 24 and the input section 25 as well as a storage medium storing the program, also constitute an embodiment of the present invention.

### (Configuration of Evaluation Information Management Apparatus for Transmitting Query Information to Mobile Terminal)

The evaluation information management apparatus 3 is equipped with a function for transmitting query information that inquires for an evaluation of a facility to the mobile terminal 2. To this end, the evaluation information management apparatus 3 includes: a location information reception section 31, a location information management table 32, a location information updating section 33, a facility information management table 34, a facility information extraction section 35, a stay determination time management table 36, a facility stay determination section 37, a query information management table 38, a user information management table 39, and an inquiry section 40.

The location information reception section (location information acquisition section) 31 receives mobile terminal location information transmitted from the location information transmission section 22. The location information reception section 31 outputs the received mobile terminal location information to the location information updating section 33.

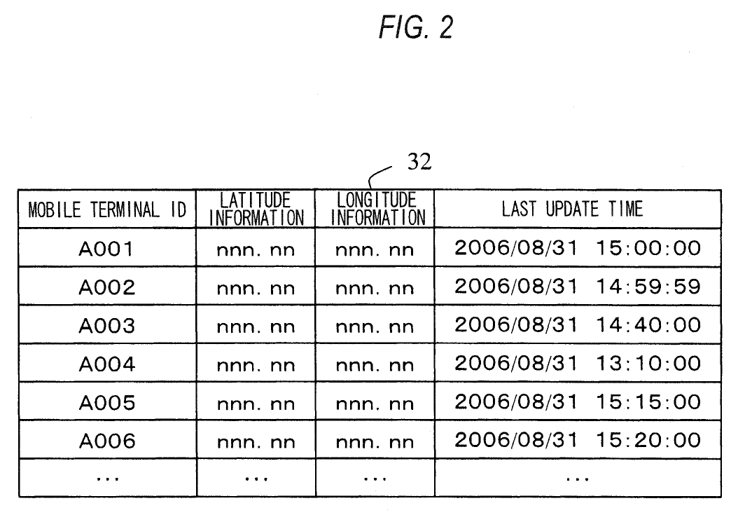

The location information management table (location information storage section) 32 stores mobile terminal location information indicating the present location of the mobile terminal 2. FIG. 2 is a diagram showing an example of a data structure of the location information management table 32. In the example shown in FIG. 2, the location information management table 32 stores mobile terminal IDs, latitude information, longitude information, and last update times. A mobile terminal ID is an identification code for uniquely identifying the mobile terminal 2. In a case where the mobile terminal 2 is, for instance, an IP (Internet Protocol) phone, an IP address, a MAC (Media Access Control) address or the like will be the mobile terminal ID. Latitude information is information indicating the latitude of the present location of the mobile terminal 2. Longitude information is information indicating the longitude of the present location of the mobile terminal 2. A last update time indicates the time at which latitude information and longitude information was last updated by the location information updating section 33.

The location information updating section 33 updates the mobile terminal location information stored in the location information management table 32 to the mobile terminal location information received by the location information reception section 31. More specifically, the location information updating section 33 extracts a mobile terminal ID, latitude information and longitude information from the mobile terminal location information output by the location information reception section 31. Based on the extracted mobile terminal ID, the location information updating section 33 updates the latitude information and longitude information stored in the location information management table 32 to the extracted latitude information and longitude information. The location information updating section 33 writes the time at which the latitude information and longitude information was updated into the last update time of the location information management table 32.

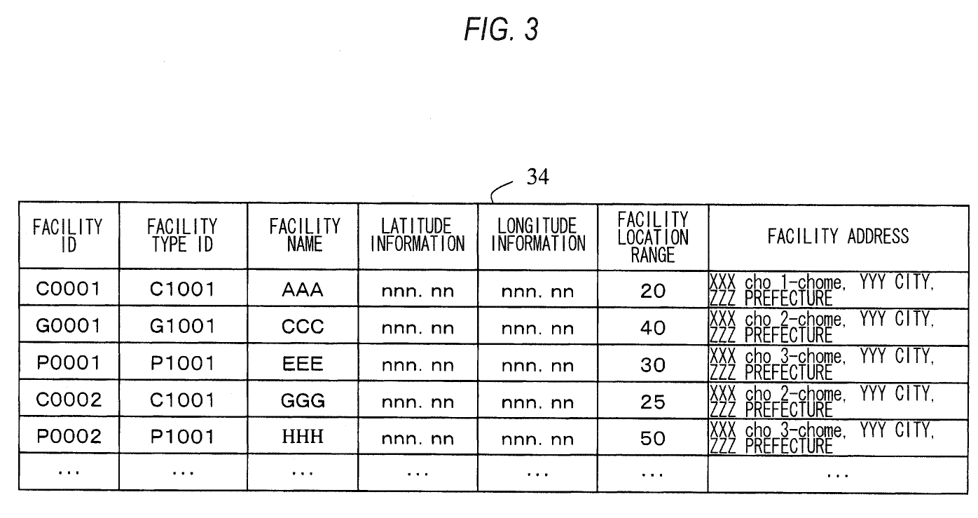

The facility information management table (facility information storage section) 34 stores facility information identifying a facility and facility location information indicating the location range of the facility. FIG. 3 is a diagram showing an example of a data structure of the facility information management table 34. In the example shown in FIG. 3, the facility information management table 34 stores facility IDs, facility type IDs, facility names, latitude information, longitude information, location ranges of facilities, and facility addresses. A facility ID is an identification code for uniquely identifying a facility. A facility type ID is an identification code for uniquely identifying a facility type. A facility name indicates the name of a facility. Latitude information is information indicating the latitude at a facility location. Longitude information is information indicating the longitude at a facility location. A location range of a facility indicates a radius from a center location of the facility represented by the latitude information and the longitude information. In the present embodiment, a location range of a facility is denominated in meters. In this case, a location range of a facility is set to a radius that, for instance, includes the entire building of the facility. A facility address indicates the address of a facility. More specifically, facility information includes the above-mentioned facility ID, facility type ID and facility name. In addition, facility location information includes the above-mentioned latitude information, longitude information, and location range of the facility.

When the present location of the mobile terminal 2 indicated by the mobile terminal location information indicates a location within the location range of the facility indicated by the facility location information, the facility information extraction section 35 extracts facility information indicating the facility from the facility information management table 34. More specifically, the facility information extraction section 35 extracts mobile terminal location information stored in the location information management table 32. The facility information extraction section 35 compares the extracted mobile terminal location information with the facility location information stored in the facility information management table 34, and determines whether the present location of the mobile terminal 2 indicated by the mobile terminal location information indicates a location within the location range of the facility indicated by the facility location information. When it is determined that the present location of the mobile terminal 2 is within the location range of the facility, the facility information extraction section 35 extracts facility information indicating this facility from the facility information management table 34. The facility information extraction section 35 outputs the extracted facility information together with mobile terminal location information to the facility stay determination section 37.

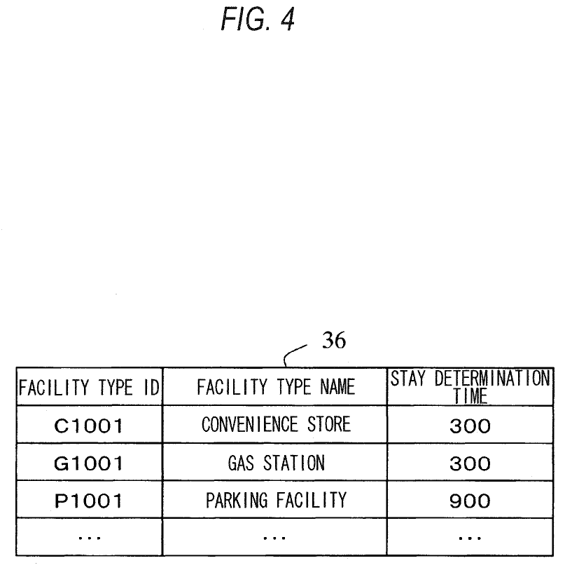

The stay determination time management table (stay determination time storage section) 36 stores a stay determination time indicating a threshold on whether the user of the mobile terminal 2 is staying at the facility indicated by the facility information extracted by the facility information extraction section 35. FIG. 4 is a diagram showing an example of a data structure of the facility stay time management table 36. In the example shown in FIG. 4, the stay determination time management table 36 stores facility type IDs, facility time names, and stay determination times. A facility type name indicates the name of a facility type. In the present embodiment, convenience stores, gas stations and parking facilities are stored as facility type names. A stay determination time, which is stored for each facility type, is a time indicating a threshold on whether the user of the mobile terminal 2 is staying at a facility. In the present embodiment, a stay determination time is denominated in seconds.

It should be noted that although an example has been described above in which stay determination times respectively corresponding to each facility type are stored in the stay determination time management table 36, the stay determination time management table 36 is not limited to this arrangement. For instance, stay determination times respectively corresponding to each facility may be stored in the stay determination time management table 36.

When the present location of the mobile terminal 2 indicated by the mobile terminal location information indicates a location within the location range of the facility indicated by the facility location information over a period of time equal to or exceeding the stay determination time, the facility stay determination section 37 determines that the user of the mobile terminal 2 is staying at the facility indicated by the facility information extracted by the facility information extraction section 35.

More specifically, the facility stay determination section 37 extracts facility location information stored in the facility information management table 34 based on the facility ID indicated by the facility information outputted from the facility information extraction section 35. In addition, the facility stay determination section 37 extracts a stay determination time stored in the stay determination time management table 36 based on the facility type ID indicated by the facility information outputted from the facility information extraction section 35. The facility stay determination section 37 determines whether the present location of the mobile terminal 2 indicates a location within the location range of the facility over a period of time equal to or exceeding the stay determination time, by performing counting (measurement) with a timer and using as a starting point the time at which the present location of the mobile terminal 2, indicated by the mobile terminal location information outputted from the facility information extraction section 35, indicates a location within the location range of the facility indicated by the facility location information. The counting results of the timer are stored in a memory, not shown.

When the facility stay determination section 37 determines that the present location of the mobile terminal 2 indicates a location within the location range of the facility over a period of time equal to or exceeding the stay determination time, the facility stay determination section 37 determines that the user of the mobile terminal 2 is staying at the facility indicated by facility information extracted by the facility information extraction section 35. On the other hand, when the facility stay determination section 37 determines that the present location of the mobile terminal 2 indicates a location within the location range of the facility over a period of time that is shorter than the stay determination time, the facility stay determination section 37 determines that the user of the mobile terminal 2 is not staying at the facility indicated by facility information extracted by the facility information extraction section 35. The facility stay determination section 37 outputs the determination results to the inquiry section 40 together with mobile terminal location information and facility information.

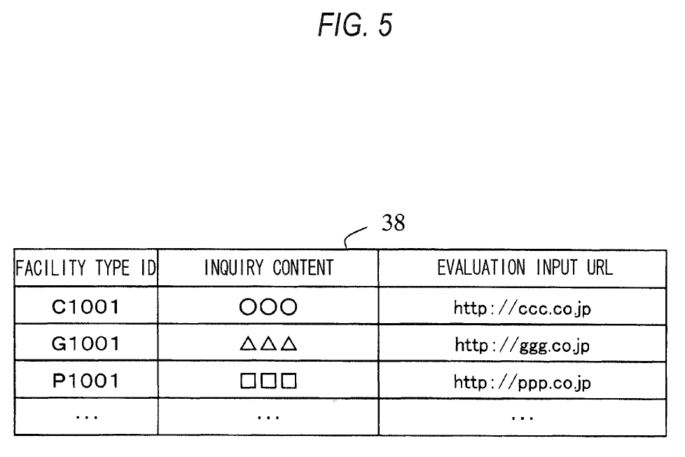

The query information management table 38 stores query information for inquiring for an evaluation of a facility. FIG. 5 is a diagram showing an example of a data structure of the query information management table 38. In the example shown in FIG. 5, the query information management table 38 stores facility type IDs, inquiry contents, as well as evaluation input URLs (Uniform Resource Locators). An inquiry content indicates a content for inquiring for an evaluation of a facility. An evaluation input URL indicates a URL for inputting an evaluation of a facility. Query information includes the above-mentioned inquiry content and an evaluation input URL.

It should be noted that although an example has been described above in which query information respectively corresponding to each facility type are stored in the query information management table 38, the query information management table 38 is not limited to this arrangement. For instance, query information respectively corresponding to each facility may be stored in the query information management table 38.

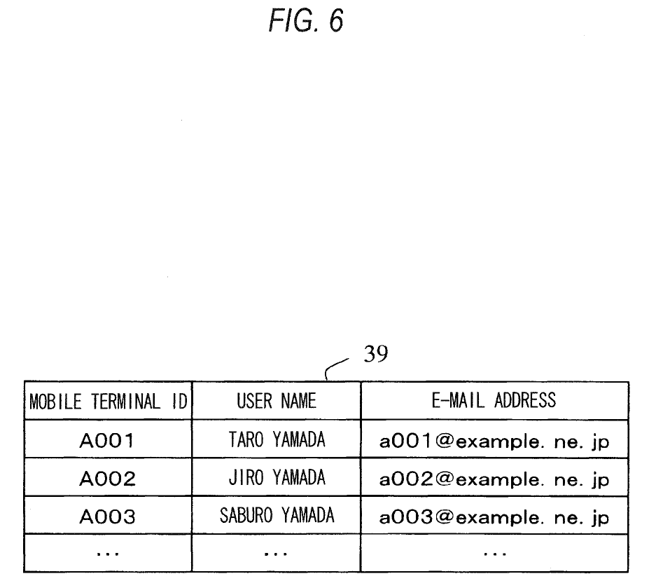

The user information management table 39 stores information on the user of the mobile terminal 2. FIG. 6 is a diagram showing an example of a data structure of the user information management table 39. In the example shown in FIG. 6, the user information management table 39 stores mobile terminal IDs, user names, and e-mail addresses. A user name indicates a name of a user. An e-mail address indicates an e-mail address of the mobile terminal 2. The mobile terminal IDs, the user names and the e-mail addresses stored in the user information management table 39 are set in advance by an administrator of the evaluation information management apparatus 3.

When the facility stay determination section 37 determines that the user of the mobile terminal 2 is staying at a facility, the inquiry section 40 transmits (outputs) query information for inquiring for an evaluation on the facility to the mobile terminal 2.

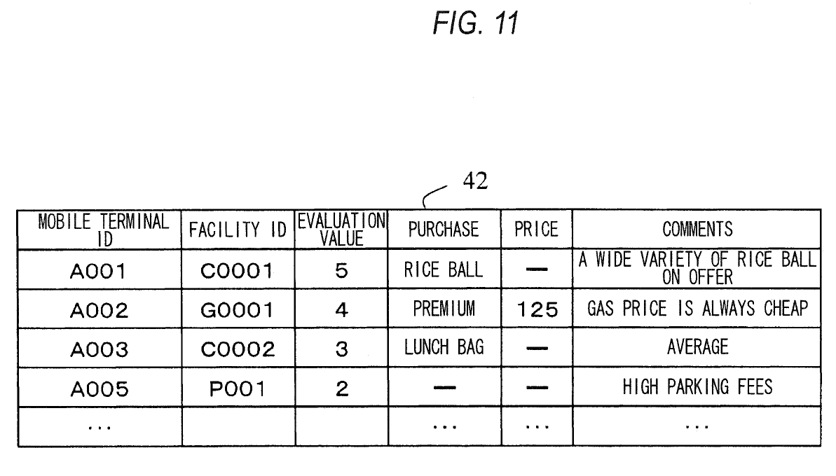

More specifically, the inquiry section 40 determines whether a mobile terminal ID indicated by the mobile terminal location information outputted from the facility stay determination section 37 as well as a facility ID indicated by the facility information outputted from the facility stay determination section 37 are stored on a same record in an evaluation information management table 42 (refer to FIG. 11), to be described later.

When the inquiry section 40 determines that the above-mentioned mobile terminal ID and facility ID are stored on the same record in the evaluation information management table 42, the inquiry section 40 determines that a reply to the query information has already been made by the user of the mobile terminal 2. In this case, the inquiry section 40 does not transmit query information to the mobile terminal 2. On the other hand, when the inquiry section 40 determines that the above-mentioned mobile terminal ID and facility ID are not stored on the same record in the evaluation information management table 42, the inquiry section 40 either determines that a reply to the query information has not been made by the user of the mobile terminal 2 or that query information has not been transmitted to the mobile terminal 2. In this case, the inquiry section 40 extracts query information stored in the query information management table 38 based on the facility type ID indicated by the facility information outputted from the facility stay determination section 37. In addition, the inquiry section 40 extracts an e-mail address stored in the user information management table 39 based on the mobile terminal ID indicated by the mobile terminal location information outputted from the facility stay determination section 37. The inquiry section 40 transmits the extracted query information to the mobile terminal 2 based on the extracted e-mail address.

### (Example of Query Information Displayed on Display Section of Mobile Terminal)

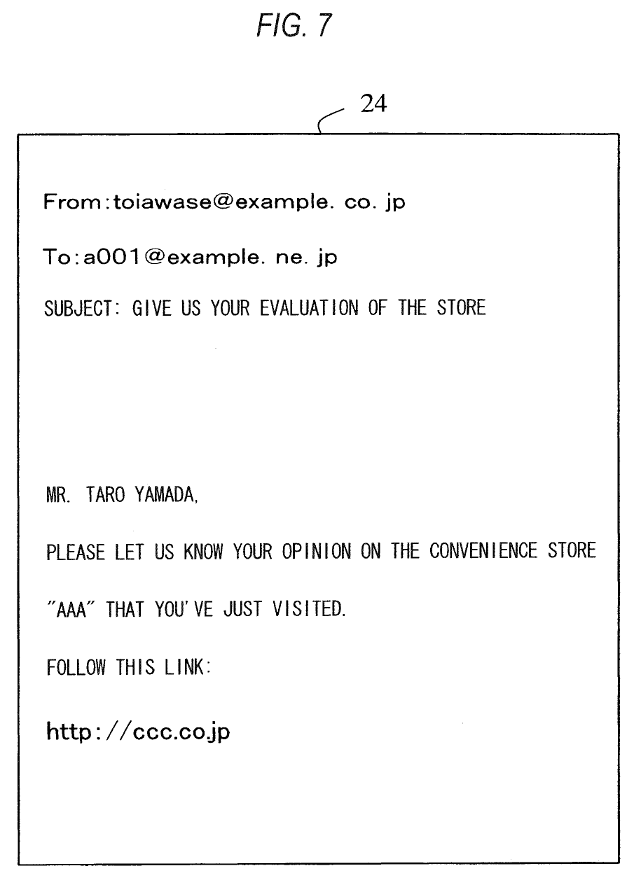

As an example, assume that the inquiry section 40 has transmitted query information for inquiring for an evaluation of a facility “AAA” belonging to the facility type “convenience store” to the mobile terminal 2a. FIG. 7 is a schematic diagram showing an example of query information to be displayed on the display section 24 of the mobile terminal 2a. As shown in FIG. 7, displayed on the display section 24 are: a subject “Give us your evaluation of the store”; a user name “Taro Yamada”; an inquiry content “Please let us know your opinion on the convenience store AAA that you've just visited”; and an evaluation input URL “http://ccc.co.jp”.

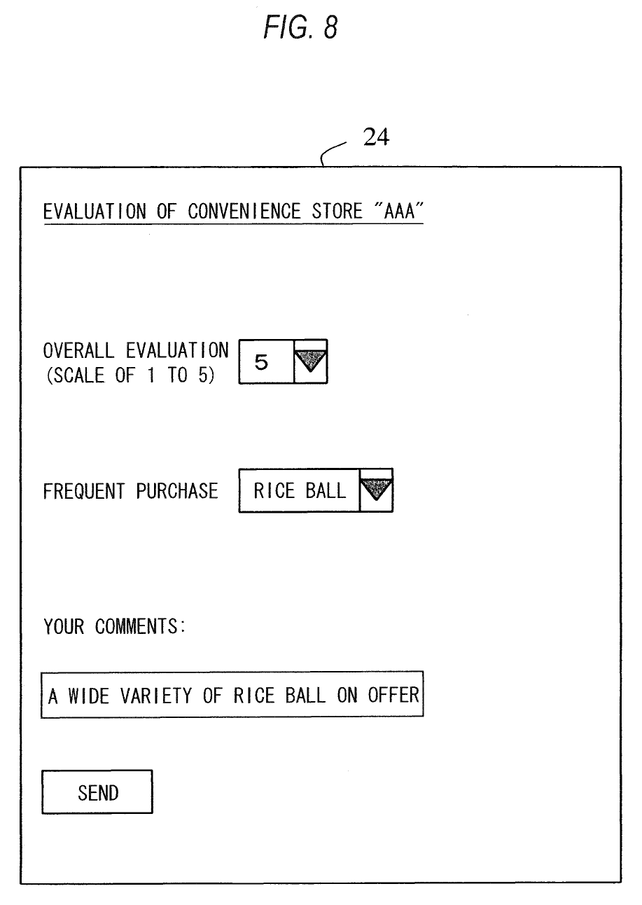

In the example shown in FIG. 7, when the user of the mobile terminal 2a specifies the evaluation input URL “http://ccc.co.jp” via the input section 25, the mobile terminal 2a accesses a web server, not shown, and acquires a web page (query information) represented by the URL “http://ccc.co.jp”. The acquired query information is displayed on the display section 24. FIG. 8 is a schematic diagram showing an example of query information represented by the URL “http://ccc.co.jp” that is displayed on the display section 24 of the mobile terminal 2a. As shown in FIG. 8, displayed on the display section 24 are the words “overall evaluation (on a scale of 1 to 5)”; an overall evaluation selection field; the words “frequent purchase”; a frequent purchase selection field; the words “your comments”; a comment input field; and a send button. The selection fields are represented as pull-down menus. In the example shown in FIG. 8, “5” and “rice ball” are respectively selected as an overall evaluation and a frequent purchase, and “a wide variety of rice balls on offer” is inputted as a comment.

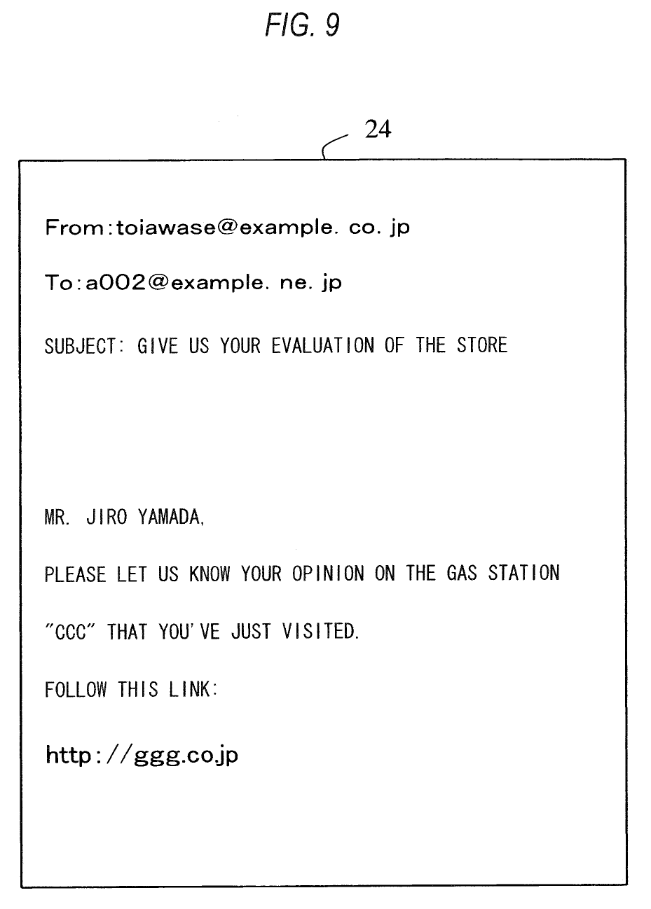

As another example, assume that the inquiry section 40 has transmitted query information for inquiring for an evaluation of a facility “CCC” belonging to the facility type “gas station” to the mobile terminal 2b. FIG. 9 is a schematic diagram showing an example of query information to be displayed on the display section 24 of the mobile terminal 2b. As shown in FIG. 9, displayed on the display section 24 are: a subject “Give us your evaluation of the store”; a user name “Jiro Yamada”; an inquiry content “Please let us know your opinion on the gas station CCC that you've just visited”; and an evaluation input URL “http://ggg.co.jp”.

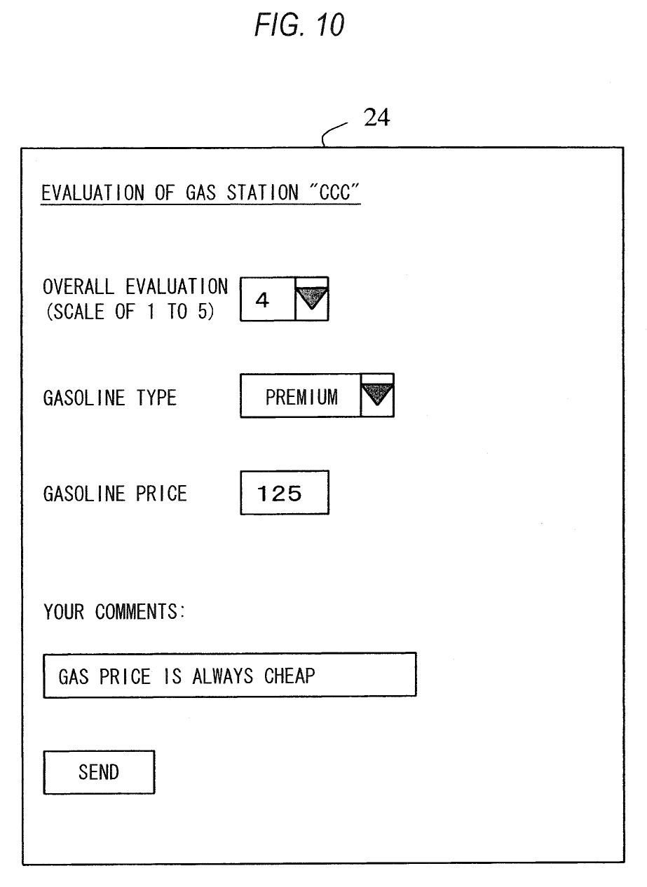

In the example shown in FIG. 9, when the user of the mobile terminal 2b specifies the evaluation input URL “http://ggg.co.jp” via the input section 25, the mobile terminal 2b accesses a web server, not shown, and acquires a web page (query information) represented by the URL “http://ggg.co.jp”. The acquired query information is displayed on the display section 24. FIG. 10 is a schematic diagram showing an example of query information represented by the URL “http://ggg.co.jp” that is displayed on the display section 24 of the mobile terminal 2b. As shown in FIG. 10, displayed on the display section 24 are: the words “overall evaluation (on a scale of 1 to 5)”; an overall evaluation selection field; the words “gasoline type”; a gasoline type selection field; the words “gas unit price”, a gas unit price input field; the words “your comments:”; a comment input field; and a send button. The selection fields are represented as pull-down menus. In the example shown in FIG. 10, “4” and “premium” are respectively selected as an overall evaluation and a gasoline type, and “125” is inputted as a gas unit price while “gas price is always cheap” is inputted as a comment.

In the cases shown in FIGS. 8 and 10, when the user of the mobile terminal 2 specifies the transmission button displayed on the display section 24 using the input section 25, the response section 23 of the mobile terminal 2 transmits the evaluation information inputted via the input section 25 to the evaluation information management apparatus 3.

### (Configuration of Evaluation Information Management Apparatus for Receiving Evaluation Information from Mobile Terminal and Storing the Information)

The evaluation information management apparatus 3 is also equipped with a function for receiving evaluation information from the mobile terminal 2 and storing the evaluation information. To this end, the evaluation information management apparatus 3 further includes an evaluation information reception section 41 and an evaluation information management table 42.

The evaluation information reception section 41 receives evaluation information transmitted from the mobile terminal 2. The evaluation information reception section 41 writes the received evaluation information into the evaluation information management table 42.

The evaluation information management table (evaluation information storage section) 42 stores evaluation information. FIG. 11 is a diagram showing an example of a data structure of the evaluation information management table 42. In the example shown in FIG. 11, mobile terminal IDs, facility IDs, evaluation values, purchases, prices and comments are stored. An evaluation value indicates an evaluation value of a facility. An evaluation value corresponds to the “overall evaluation” shown in FIGS. 8 and 10. In the present embodiment, an evaluation value is expressed on a scale of 1 to 5. A purchase indicates an item purchased at the facility. A purchase corresponds to the “frequent purchase” shown in FIG. 8 and the “gasoline type” shown in FIG. 10. A price indicates the price of a purchase. A price corresponds to the “gas unit price” shown in FIG. 10. In the present embodiment, prices are denominated in Japanese yen. A comment indicates a comment made by the user on the facility. The contents entered in the comment input fields shown in FIGS. 8 and 10 are stored as comments.

### (Configuration of Evaluation Information Management Apparatus for Distributing Evaluation Information to Mobile Terminal)

The evaluation information management apparatus 3 is also equipped with a function for distributing evaluation information stored in the evaluation information management table 42 to the mobile terminal 2. To this end, the evaluation information management apparatus 3 further includes a request reception section 43, an evaluation information extraction section 44, and an evaluation information distribution section 45.

The request reception section 43 receives request information indicating a request for acquiring evaluation information from the mobile terminal 2. The request reception section 43 outputs request information received from the mobile terminal 2 to the facility information extraction section 35. Request information includes the mobile terminal ID of the mobile terminal 2 that transmitted the request information.

The facility information extraction section 35 extracts facility information indicating a facility located within a predetermined range from the present location of the mobile terminal 2 that transmitted the request information from the facility information management table 34. More specifically, the facility information extraction section 35 extracts mobile terminal location information stored in the location information management table 32 based on the mobile terminal ID indicated by the request information outputted from the request reception section 43. The facility information extraction section 35 extracts facility information indicating a facility located within a predetermined range from the present location of the mobile terminal 2 indicated by the mobile terminal location information from the facility information management table 34. The facility information extraction section 35 outputs the extracted facility information together with the request information to the evaluation information extraction section 44.

The evaluation information extraction section 44 extracts evaluation information stored in the evaluation information management table 42 based on the facility ID indicated by the facility information outputted from the facility information extraction section 35. The evaluation information extraction section 44 outputs the evaluation information together with the request information to the evaluation information distribution section 45.

The evaluation information distribution section 45 distributes evaluation information extracted by the evaluation information extraction section 44 to the mobile terminal 2 that transmitted the request information. More specifically, the evaluation information distribution section 45 extracts an e-mail address stored in the user information management table 39 based on the mobile terminal ID indicated by the request information outputted from the evaluation information extraction section 44. Based on the extracted e-mail address, the evaluation information distribution section 45 distributes evaluation information to the mobile terminal 2 that transmitted the request information. As a result, according to a request from the mobile terminal 2 for acquiring evaluation information, the evaluation information distribution section 45 is able to distribute evaluation information on a facility located within a predetermined range from the present location of the mobile terminal 2 to the mobile terminal 2 that transmitted the request information. Therefore, the user of the mobile terminal 2 is able to utilize distributed evaluation information as a criterion for deciding whether the facility should be visited.

Incidentally, while a case has been described above in which the request reception section 43 receives request information indicating a request for acquiring evaluation information from the mobile terminal 2 and the evaluation information distribution section 45 distributes evaluation information to the mobile terminal 2 that transmitted the request information, the evaluation information management apparatus 3 is not limited to this arrangement. For example, the evaluation information management apparatus 3 may be arranged so that, without receiving request information from the mobile terminal 2, the evaluation information distribution section 45 distributes evaluation information to the mobile terminal 2 based on mobile terminal location information stored in the location information management table 32.

More specifically, the facility information extraction section 35 extracts mobile terminal location information stored in the location information management table 32. The facility information extraction section 35 extracts facility information indicating a facility located within a predetermined range from the present location of the mobile terminal 2 indicated by the extracted mobile terminal location information from the facility information management table 34. The evaluation information extraction section 44 extracts evaluation information stored in the evaluation information management table 42 based on the facility information extracted by the facility information extraction section 35. The evaluation information distribution section 45 distributes evaluation information extracted by the evaluation information extraction section 44 to the mobile terminal 2. As a result, for example, even if request information indicating a request for acquiring evaluation information is not received from the mobile terminal 2, the evaluation information distribution section 45 is able to distribute evaluation information on a facility located within a predetermined range from the present location of the mobile terminal 2 to the mobile terminal 2 indicated by the mobile terminal location information stored in the location information management table 32. More specifically, the user of the mobile terminal 2 is no longer required to issue a request for acquiring evaluation information using the input section 25. In such a case, the request reception section 43 need not be provided in the evaluation information management apparatus 3.

### (Configuration of Evaluation Information Management Apparatus for Notifying User Information to Facility Computer)

The evaluation information management apparatus 3 further includes a function for notifying a facility computer 4 of information on the user of the mobile terminal 2 that provided evaluation information in the event that the user is staying at a facility that is an object of evaluation information distributed from the evaluation information distribution section 45 to the mobile terminal 2. To this end, the evaluation information management apparatus 3 further includes a notification section 46.

The facility stay determination section 37 determines whether the user of the mobile terminal 2 is staying at the facility that is an object of evaluation information distributed from the evaluation information distribution section 45 to the mobile terminal 2. The facility stay determination section 37 outputs the determination result to the notification section 46.

When the facility stay determination section 37 determines that the user of the mobile terminal 2 is staying at the facility, the notification section 46 notifies a facility computer 4 installed at the facility of information on the user of the mobile terminal 2 that provided the evaluation information. More specifically, the notification section 46 extracts user information stored in the user information management table 39 based on the mobile terminal ID of the mobile terminal 2 that provided the evaluation information. In other words, the notification section 46 extracts the name of the user that provided the evaluation information as well as an e-mail address corresponding to the user name. Based on the e-mail address of the facility computer 4, the notification section 46 notifies the facility computer 4 of the extracted user information. Consequently, the administrator of the facility is able to return a portion of the profits of the facility to the user that provided evaluation information. For example, to a user that has provided evaluation information, the administrator of the facility may provide merchandise of the facility at discounted prices or grant privileges in the form of giveaways or the like.

Incidentally, the evaluation information management apparatus 3 described above may also be realized by installing a program in an arbitrary computer such as a personal computer. More specifically, the location information reception section 31, the location information updating section 33, the facility information extraction section 35, the facility stay determination section 37, the inquiry section 40, the evaluation information reception section 41, the request reception section 43, the evaluation information extraction section 44, the evaluation information distribution section 45 and the notification section 46 may be realized when a CPU of the computer operates in accordance with a program that realizes these functions. Therefore, a program for realizing the functions of the location information reception section 31, the location information updating section 33, the facility information extraction section 35, the facility stay determination section 37, the inquiry section 40, the evaluation information reception section 41, the request reception section 43, the evaluation information extraction section 44, the evaluation information distribution section 45 and the notification section 46, as well as a storage medium storing the program also constitute an embodiment of the present invention. Furthermore, the location information management table 32, the facility information management table 34, the stay determination time management table 36, the query information management table 38, the user information management table 39 and the evaluation information management table 42 may be realized by an internal storage device of the computer or a storage device accessible from the computer.

The respective components 31 to 46 that constitute the evaluation information management apparatus 3, described above, may be configured by integrating the components into a single apparatus or may be configured by distributing the components into a plurality of apparatuses. For instance, when the mobile terminal 2 is a terminal device such as an automotive navigation system or on-vehicle equipment provided on a mobile unit such as a vehicle, components provided in the evaluation information management apparatus 3 such as the facility information management table 34, the facility information extraction section 35, the stay determination time management table 36, the facility stay determination section 37, the query information management table 38, and the inquiry section 40 may be provided within the mobile terminal 2.

### (Example of Operation of Evaluation Information Distribution System)

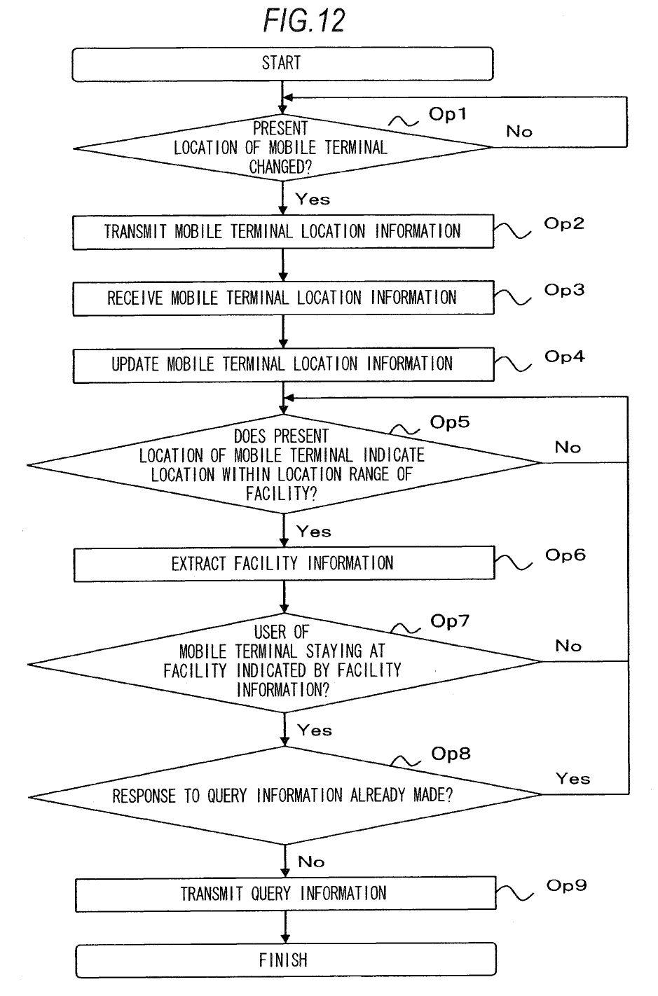

Next, processing performed by the evaluation information distribution system 1 according to the above configuration will be described with reference to FIGS. 12 to 15.

FIG. 12 is a flowchart showing an outline of processing for transmitting query information from the evaluation information management apparatus 3 to the mobile terminal 2. As shown in FIG. 12, when the present location of the mobile terminal 2 changes (YES in operation Op1), the present location measurement section 21 outputs mobile terminal location information indicating the present location of the mobile terminal 2 to the location information transmission section 22. The location information transmission section 22 transmits the mobile terminal location information outputted from the present location measurement section 21 to the evaluation information management apparatus 3 (operation Op2). On the other hand, if the present location of the mobile terminal 2 does not change (NO in operation Op1), the routine returns to operation Op1.

Then, the location information reception section 31 of the evaluation information management apparatus 3 receives the mobile terminal location information transmitted in operation Op2 (operation Op3). The location information updating section 33 updates the mobile terminal location information stored in the location information management table 32 to the mobile terminal location information received in operation Op3 (operation Op4).

Next, when it is determined that the present location of the mobile terminal 2 indicated by the mobile terminal location information stored in the location information management table 32 indicates a location within the location range of the facility indicated by the facility location information stored in the facility information management table 34 (YES in operation Op5), the facility information extraction section 35 extracts facility information indicating this facility from the facility information management table 34 (operation Op6). On the other hand, if it is determined that the present location of the mobile terminal 2 does not indicate a location within the location range of the facility (NO in operation Op5), the facility information extraction section 35 returns to operation Op5.

The facility stay determination section 37 determines whether the user of the mobile terminal 2 is staying at the facility indicated by the facility information extracted in operation Op6. More specifically, the facility stay determination section 37 determines whether the present location of the mobile terminal 2 indicated by the mobile terminal location information indicates a location within the location range of the facility indicated by the facility location information over a period of time equal to or exceeding the stay determination time by performing counting (measurement) with a timer and using as a starting point the time at which the present location of the mobile terminal 2 indicates a location within the location range of the facility. When the facility stay determination section 37 determines that the present location of the mobile terminal 2 indicates a location within the location range of the facility over a period of time equal to or exceeding the stay determination time, the facility stay determination section 37 determines that the user of the mobile terminal 2 is staying at the facility indicated by the facility information extracted in operation Op6 (YES in operation Op7). In this case, the routine proceeds to operation Op8. On the other hand, when the facility stay determination section 37 determines that the present location of the mobile terminal 2 indicates a location within the location range of the facility over a period of time that is shorter than the stay determination time, the facility stay determination section 37 determines that the user of the mobile terminal 2 is not staying at the facility indicated by facility information extracted in operation Op6 (NO in operation Op7). In this case, the routine returns to operation Op5.

The inquiry section 40 determines whether the mobile terminal ID indicated by the mobile terminal location information and the facility ID indicated by the facility information are stored on a same record in the evaluation information management table 42. More specifically, when the inquiry section 40 determines that the above-mentioned mobile terminal ID and facility ID are stored on the same record in the evaluation information management table 42, the inquiry section 40 determines that a reply to the query information has already been made by the user of the mobile terminal 2 (YES in operation Op8). In this case, the routine returns to operation Op5. On the other hand, when the inquiry section 40 determines that the above-mentioned mobile terminal ID and facility ID are not stored on the same record in the evaluation information management table 42, the inquiry section 40 either determines that a reply to the query information has hot been made by the user of the mobile terminal 2 or that query information has not been transmitted to the mobile terminal 2 (NO in operation Op8). In this case, the routine proceeds to operation Op9, whereby the inquiry section 40 transmits query information to the mobile terminal 2 (operation Op9). Query information transmitted in operation Op9 is displayed on the display section 24 of the mobile terminal 2.

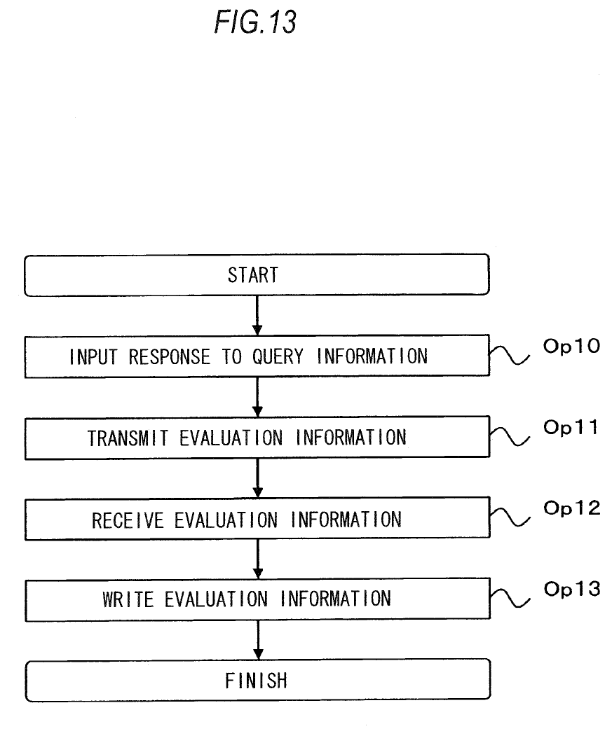

FIG. 13 is a flowchart showing an outline of processing for transmitting evaluation information from the mobile terminal 2 to the evaluation information management apparatus 3. As shown in FIG. 13, the input section 25 of the mobile terminal 2 enables the user of the mobile terminal 2 to input a reply to the query information transmitted in operation Op9 shown in FIG. 12 (operation Op10). The response section 23 transmits the inputted evaluation information to the evaluation information management apparatus 3 (operation Op11).

Then, the evaluation information reception section 41 of the evaluation information management apparatus 3 receives the evaluation information transmitted in operation Op11 (operation Op12). The evaluation information reception section 41 writes the received evaluation information into the evaluation information management table 42 (operation Op13). As a result, evaluation information is stored in the evaluation information management table 42 as shown in FIG. 11.

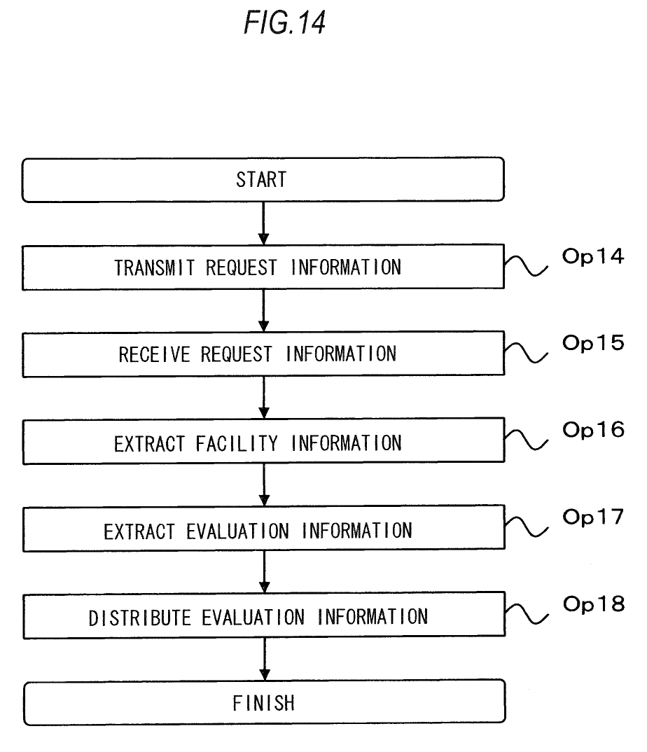

FIG. 14 is a flowchart showing an outline of processing for distributing evaluation information from the evaluation information management apparatus 3 to the mobile terminal 2. As shown in FIG. 14, when the user of the mobile terminal 2 issues a request for acquiring evaluation information using the input section 25, the response section 23 transmits the request information to the evaluation information management apparatus 3 (operation Op14).

Then, the request reception section 43 of the evaluation information management apparatus 3 receives the request information transmitted in operation Op14 (operation Op15). The facility information extraction section 35 extracts facility information indicating a facility located within a predetermined range from the present location of the mobile terminal 2 that transmitted the request information in operation Op14 from the facility information management table 34 (operation Op16). The evaluation information extraction section 44 extracts evaluation information stored in the evaluation information management table 42 based on the facility information extracted in operation Op16 (operation Op17). The evaluation information distribution section 45 distributes evaluation information extracted in operation Op17 to the mobile terminal 2 that transmitted the request information (operation Op18).

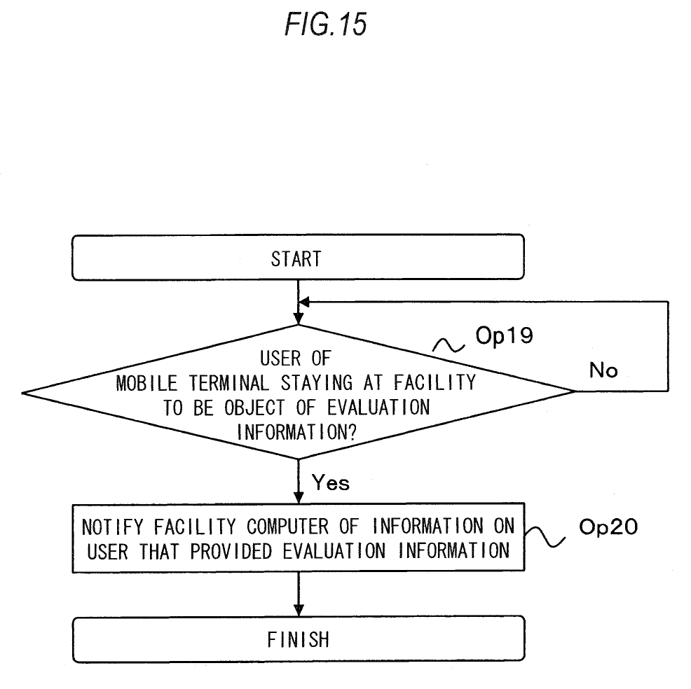

FIG. 15 is a flowchart showing an example of a process for supplying user information from the evaluation information management apparatus 3, to the facility computer 4. As shown in FIG. 15, when the facility stay determination section 37 determines that the user of the mobile terminal 2 to which evaluation information was distributed in operation Op18 is staying at the facility that is an object of the evaluation information distributed in operation Op18 (YES in operation Op19), the notification section 46 notifies the facility computer 4 installed at this facility of information on the user that provided the evaluation information (operation Op20). On the other hand, when the facility stay determination section 37 determines that the user of the mobile terminal 2 to which evaluation information was distributed in operation Op18 is not staying at the facility that is an object of the evaluation information distributed in operation Op18 (NO in operation Op19), the routine returns to operation Op19.

As seen, in the evaluation information distribution system 1 according to the present embodiment, the facility stay determination section 37 determines whether the user of the mobile terminal 2 is staying at the facility indicated by the facility information extracted by the facility information extraction section 35 based on information on the mobile terminal 2. In this case, information on the mobile terminal 2 is, for instance, mobile terminal location information indicating the present location of the mobile terminal 2. Accordingly, when the facility stay determination section 37 determines that the user is not staying at the facility, the inquiry section 40 does not output query information for inquiring for an evaluation on the facility to the user of the mobile terminal 2. On the other hand, when the facility stay determination section 37 determines that the user is staying at the facility, the inquiry section 40 outputs query information for inquiring for an evaluation on the facility to the user of the mobile terminal 2. Therefore, in the event that the user of the mobile terminal 2 is staying at the facility, the evaluation information distribution system 1 according to the present embodiment is able to output query information for inquiring for an evaluation on the facility to the user of the mobile terminal 2.

### Second Embodiment

For the first embodiment, an example was described in which a user of a mobile terminal is determined to be staying in a facility when the present location of the mobile terminal indicates a location within a location range of the facility for a period of time that equals or exceeds a stay determination time. In contrast, for the second embodiment, an example will be described in which the user of a mobile terminal is determined to be staying at a power source providing location at which is located the mobile terminal mounted on a mobile unit in the event that an increase in the power source of the mobile unit is detected.

In this case, mobile units include wheeled vehicles, two-wheeled motor vehicles, and the like. In addition, mobile units include those that use fuel (gasoline) as a power source, those that use electricity as a power source, and those that use hydrogen as a power source.

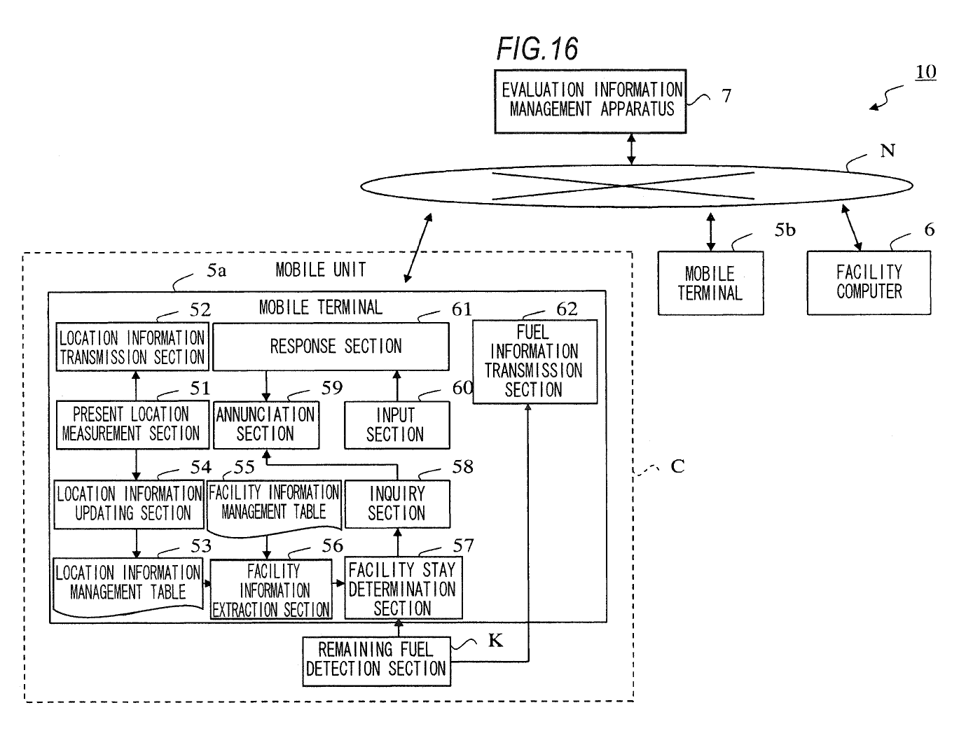

FIG. 16 is a block diagram showing a schematic configuration of an evaluation information distribution system 10 according to the present embodiment. More specifically, the evaluation information distribution system 10 according to the present embodiment includes mobile terminals (information communication systems) 5a, 5b, a facility computer 6, and an evaluation information management apparatus 7. The mobile terminals 5a, 5b, the facility computer 6, and the evaluation information management apparatus 7 are connected to each other via the Internet N. The mobile terminals 5a, 5b are, for instance, terminal devices such as automotive navigation systems or on-vehicle equipment mountable on a mobile unit C. The facility computer 6 is a computer installed at a facility. The evaluation information management apparatus 7 is an apparatus that manages evaluation information generated by the mobile terminals 5a, 5b and which indicates an evaluation of a facility.

In the present embodiment, facilities are gas stations (power source providing locations) that provide the mobile unit C with gasoline (power source). In addition, the mobile unit C is a wheeled vehicle, a two-wheeled motor vehicle, or the like, and travels while consuming gasoline. Moreover, instead of using gasoline as a power source, the mobile unit may use electricity as a power source or may use hydrogen as a power source.

Hereinafter, when describing parts having the same functions, lower case letters for distinguishing among parts having the same functions such as, for example, in the case of the mobile terminal 5a, will only be attached for descriptive purposes when such distinctions are necessary. When there is no need to distinguish or when generic designation is used, descriptions will be given without attaching lower case letters such as, for example, in the case of the mobile terminal 5.

First, before describing in detail configurations of the mobile terminal 5 and the evaluation information management apparatus 7 constituting the evaluation information distribution system 10, a brief description will be given on the function of a remaining fuel detection section K provided in the mobile unit C. In other words, the remaining fuel detection section K detects how much gasoline is remaining in the mobile unit C. More specifically, the remaining fuel detection section K detects how much gasoline is remaining in the mobile unit C by either monitoring the remaining fuel in the fuel tank of the mobile unit C or by monitoring the fuel level meter of the mobile unit C. The remaining fuel detection section K outputs the detection result to a facility stay determination section 57 and a fuel information transmission section 62, which will be described later, of the mobile terminal 5a. Alternatively, the remaining fuel detection section K may be provided inside the mobile terminal 5a.

### (Configuration of Mobile Terminal)

The mobile terminal 5a includes a present location measurement section 51, a location information transmission section 52, a location information management table 53, a location information updating section 54, a facility information management table 55, a facility information extraction section 56, the facility stay determination section 57, an inquiry section 58, an annunciation section 59, an input section 60, a response section 61, and the fuel information transmission section 62. The configuration of the mobile terminal 5b is similar to that of the mobile terminal 5a. The respective components 51 to 62 that constitute the mobile terminal 5a may be configured by integrating the components into a single apparatus or may be configured by distributing the components into a plurality of apparatuses.

The present location measurement section 51 has the same function as the present location measurement section 21 shown in FIG. 1. More specifically, the present location measurement section 51 measures the present location of the mobile terminal 5a. The present location measurement section 51 outputs mobile terminal location information indicating the present location of the mobile terminal 5a to both the location information transmission section 52 and the location information updating section 54.

The location information transmission section 52 has the same function as the location information transmission section 22 shown in FIG. 1. More specifically, the location information transmission section 52 transmits mobile terminal location information indicating the present location of the mobile terminal 5a to the evaluation information management apparatus 7.

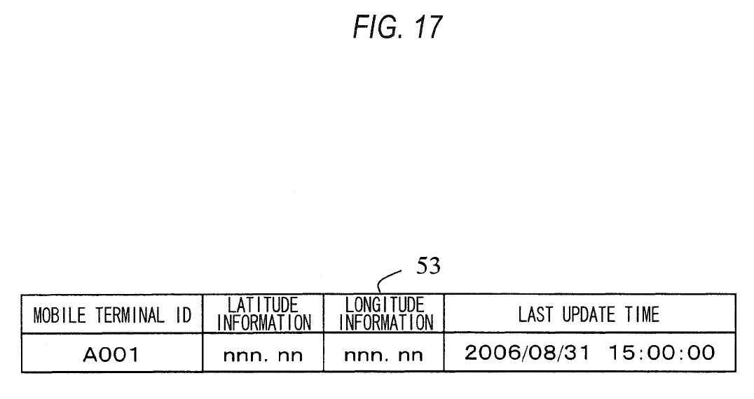

The location information management table (location information storage section) 53 stores mobile terminal location information indicating the present location of the mobile terminal 5a. FIG. 17 is a diagram showing an example of a data structure of the location information management table 53. In the example shown in FIG. 17, the location information management table 53 stores a mobile terminal ID, latitude information, longitude information, and a last update time in the same manner as the location information management table 32 shown in FIG. 2. However, the location information management table 53 shown in FIG. 17 differs from the location information management table 32 shown in FIG. 2 in that only mobile terminal location information of the mobile terminal 5a that is the table's own device is stored.

The location information updating section (location information acquisition section, location information updating section) 54 acquires mobile terminal location information outputted from the present location measurement section 51. The location information updating section 54 updates the mobile terminal location information stored in the location information management table 53 to the mobile terminal location information acquired from the present location measurement section 51.

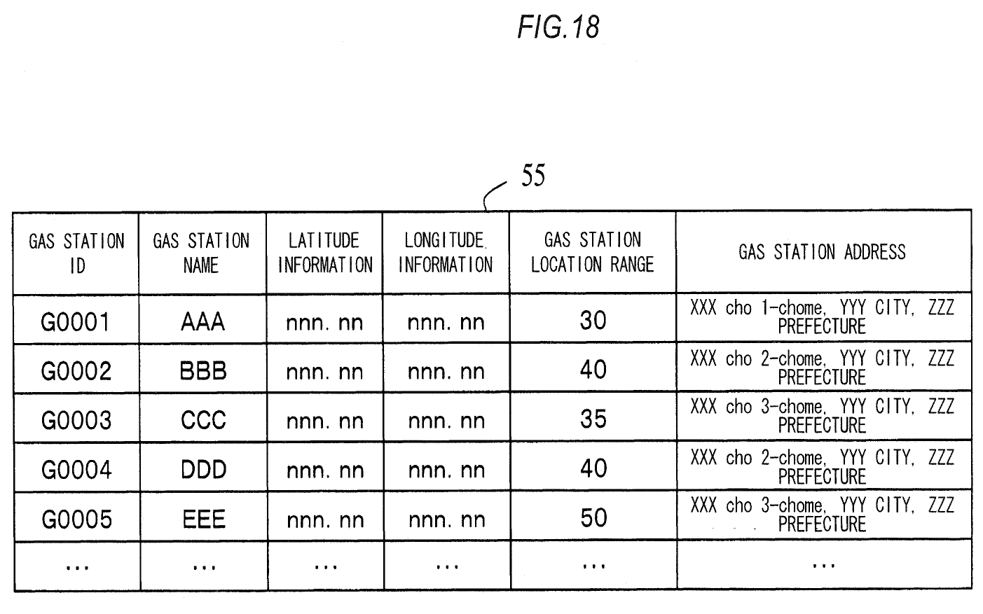

The facility information management table (facility information storage section) 55 stores facility information identifying a gas station and facility location information indicating a location range of the gas station. FIG. 18 is a diagram showing an example of a data structure of the facility information management table 55. In the example shown in FIG. 18, the facility information management table 55 stores gas station IDs, gas station names, latitude information, longitude information, location ranges of gas stations, and gas station addresses. A gas station ID is an identification code for uniquely identifying a gas station. A gas station name indicates the name of a gas station. Latitude information is information indicating the latitude of a gas station location. Longitude information is information indicating the longitude of a gas station location. A location range of a gas station indicates a radius from a center location of the gas station represented by the latitude information and the longitude information. In the present embodiment, a location range of a gas station is denominated in meters. In this case, a location range of a gas station is set to a radius that, for instance, includes the entire building of the gas station. A gas station address indicates the address of a gas station.

The facility information extraction section 56 has the same function as the facility information extraction section 35 shown in FIG. 1. More specifically, when the present location of the mobile terminal 5a indicated by the mobile terminal location information indicates a location within the location range of the gas station indicated by the facility location information, the facility information extraction section 56 extracts facility information indicating the gas station from the facility information management table 55. The facility information extraction section 56 outputs the extracted facility information to the facility stay determination section 57.

When the remaining fuel detection section K detects an increase in the gasoline of the mobile unit C, the facility stay determination section 57 determines that the user of the mobile terminal 5a is staying at the gas station indicated by the facility information extracted by the facility information extraction section 56. More specifically, in general, when an increase in the gasoline of the mobile unit C is detected by the remaining fuel detection section K, the mobile unit C is being provided (supplied) with gasoline from the gas station. In such a case, the facility stay determination section 57 determines that the user of the mobile terminal 5a is staying at the gas station indicated by the facility information extracted by the facility information extraction section 56.

When the facility stay determination section 57 determines that the user of the mobile terminal 5a is staying at a gas station, the inquiry section 58 outputs query information for inquiring the price of gasoline provided by the gas station to the annunciation section 59.

The annunciation section 59 announces query information outputted from the inquiry section 58. In addition, the annunciation section 59 announces evaluation information indicating an evaluation of the gas station that is obtained as a response to the query information (inquiry) outputted from the response section 61. The annunciation section 59 is constituted by a voice synthesis apparatus, a display section (a liquid crystal display, an organic EL display, a plasma display or a CRT display), and the like. In the present embodiment, since the mobile terminal 5a is a terminal device such as an automotive navigation system or on-vehicle equipment mountable on the mobile unit C, the annunciation section 59 is preferably a voice synthesis apparatus. This enables the user to acknowledge query information or evaluation information on a so-called eyes-free basis even when the user is driving the mobile unit C.

The input section 60 has the same function as the input section 25 shown in FIG. 1. More specifically, the input section 60 allows the user of the mobile terminal 5a to input a reply to the query information announced by the annunciation section 59. In addition, the input section 60 enables the user of the mobile terminal 5a to issue a request for acquiring evaluation information. Incidentally, in the present embodiment, the input section 60 is preferably a voice recognition apparatus. This enables the user to input a response to query information on a so-called eyes-free or hands-free basis even when the user is driving the mobile unit C.

The response section 61 has the same function as the response section 23 shown in FIG. 1. More specifically, the response section 61 transmits evaluation information inputted from the input section 60 to the evaluation information management apparatus 7. In addition, the response section 61 transmits request information inputted from the input section 60 to the evaluation information management apparatus 7. Furthermore, the response section 61 receives evaluation information distributed by the evaluation information management apparatus 7. The response section 61 outputs the received evaluation information to the annunciation section 59.

The fuel information transmission section 62 transmits fuel information indicating remaining fuel of the mobile unit C outputted from the remaining fuel detection section K to the evaluation information management apparatus 7. Fuel information includes mobile terminal location information indicating the present location of the mobile terminal 5a.

Incidentally, the mobile terminal 5a described above may also be realized by installing a program in an arbitrary computer such as a personal computer. More specifically, the present location measurement section 51, the location information transmission section 52, the location information updating section 54, the facility information extraction section 56, the facility stay determination section 57, the inquiry section 58, the annunciation section 59, the input section 60, the response section 61 and the fuel information transmission section 62 described above may be realized when a CPU of the computer operates in accordance with a program that realizes these functions. Therefore, a program for realizing the functions of the present location measurement section 51, the location information transmission section 52, the location information updating section 54, the facility information extraction section 56, the facility stay determination section 57, the inquiry section 58, the annunciation section 59, the input section 60, the response section 61 and the fuel information transmission section 62, as well as a storage medium storing the program, also constitute an embodiment of the present invention. Furthermore, the location information management table 53 and the facility information management table 55 may be realized by an internal storage device of the computer or a storage device accessible from the computer.

### (Example of Query Information Announced by Annunciation Section of Mobile Terminal)

As an example, assume that the inquiry section 58 has outputted query information for inquiring for an evaluation of a gas station “AAA” to the annunciation section 59. In this case, the annunciation section 59 outputs query information of “Please let us know your opinion on gas station AAA that you've recently visited” in a synthesized voice to the user of the mobile terminal 5a. Furthermore, the annunciation section 59 sequentially outputs query information such as “Tell us your gasoline type”, “Tell us the gasoline price” or the like in a synthesized voice. In response to the outputted query information, the user of the mobile terminal 5a replies by voicing such as “My gasoline type is regular”, “Gasoline was 115 yen” or the like. Besides those described above, the annunciation section 59 is also capable of outputting query information such as “In a scale of 1 to 5, what is your overall evaluation of the gas station AAA?”, “Do you have any comments?”, or the like in a synthesized voice. It should be understood that the contents of these query information are merely exemplary.

### (Configuration of Evaluation Information Management Apparatus for Receiving Evaluation Information from Mobile Terminal and Storing the Information)

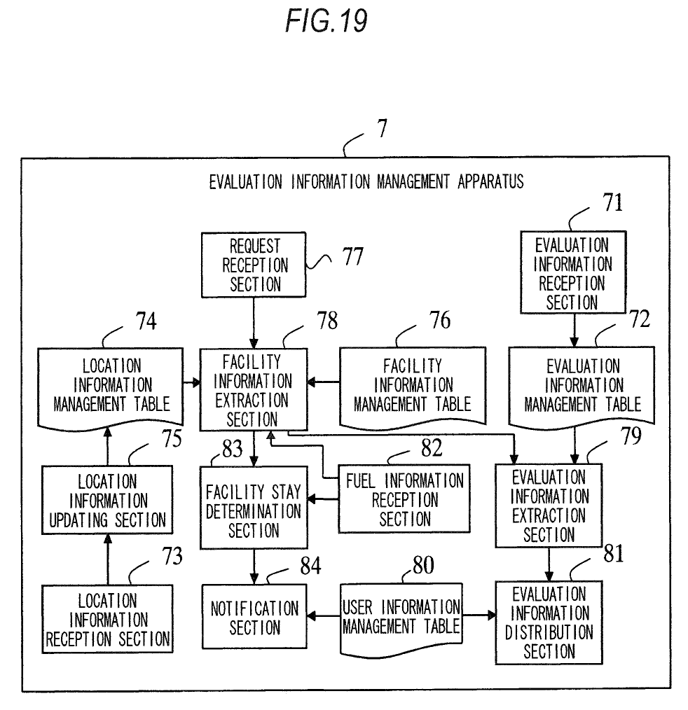

FIG. 19 is a block diagram showing a schematic configuration of the evaluation information management apparatus 7. In the same manner as the evaluation information management apparatus 3 shown in FIG. 1, the evaluation information management apparatus 7 is equipped with a function for receiving evaluation information indicating an evaluation of the gas station from the mobile terminal 5 and storing the evaluation information. To this end, the evaluation information management apparatus 7 includes an evaluation information reception section 71 and an evaluation information management table 72.

The evaluation information reception section 71 has the same function as the evaluation information reception section 41 shown in FIG. 1. More specifically, the evaluation information reception section 71 receives evaluation information transmitted from the mobile terminal 5. The evaluation information reception section 71 writes the received evaluation information into the evaluation information management table 72.

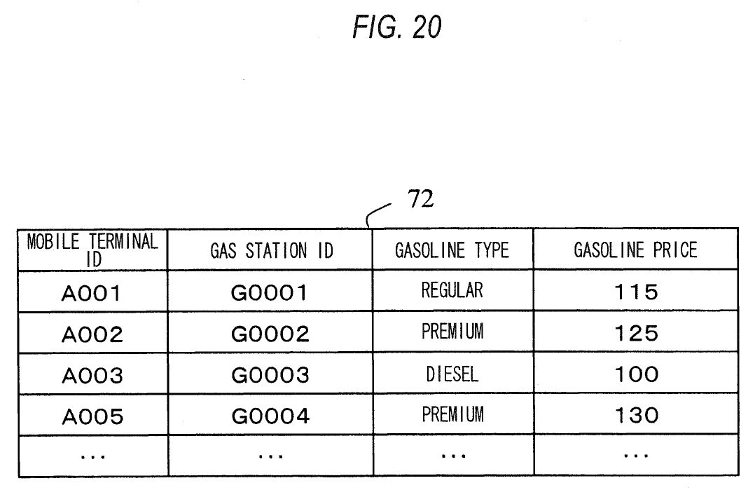

The evaluation information management table 72 stores evaluation information. FIG. 20 is a diagram showing an example of a data structure of the evaluation information management table 72. In the example shown in FIG. 20, the evaluation information management table 72 stores mobile terminal IDs, gas station IDs, gasoline types, and gasoline unit prices. A gasoline type indicates the type of gasoline. In the present embodiment, regular, premium and diesel are stored. A gasoline unit price indicates the unit price of gasoline per liter. In the present embodiment, unit prices are denominated in Japanese yen. Incidentally, the evaluation information management table 72 may also store overall evaluations of gas stations, comments, or the like.

### (Configuration of Evaluation Information Management Apparatus for Distributing Evaluation Information to Mobile Terminal)

The evaluation information management apparatus 7 is also equipped with a function for distributing evaluation information stored in the evaluation information management table 72 to the mobile terminal 5 in the same manner as the evaluation information management apparatus 3 shown in FIG. 1. To this end, the evaluation information management apparatus 7 further includes: a location information reception section 73, a location information management table 74, a location information updating section 75, a facility information management table 76, a request reception section 77, a facility information extraction section 78, an evaluation information extraction section 79, a user information management table 80, an evaluation information distribution section 81, and a fuel information reception section 82.

The location information reception section (location information acquisition section) 73 has the same function as the location information reception section 31 shown in FIG. 1. More specifically, the location information reception section 73 receives mobile terminal location information transmitted from the location information transmission section 52.

The location information management table (location information storage section) 74 stores mobile terminal location information indicating the present location of the mobile terminal 5. The data structure of the location information management table 74 is the same as the data structure of the location information management table 32 shown in FIG. 2.

The location information updating section 75 has the same function as the location information updating section 33 shown in FIG. 1. More specifically, the location information updating section 75 updates the mobile terminal location information stored in the location information management table 74 to the mobile terminal location information received by the location information reception section 73.

The facility information management table (facility information storage section) 76 stores facility information identifying a gas station and facility location information indicating a location range of the gas station. The data structure of the facility information management table 76 is the same as the data structure of the facility information management table 55 shown in FIG. 18.

The request reception section 77 has the same function as the request reception section 43 shown in FIG. 1. More specifically, the request reception section 77 receives request information indicating a request for acquiring evaluation information from the mobile terminal 5.

The facility information extraction section 78 has the same function as the facility information extraction section 35 shown in FIG. 1. More specifically, the facility information extraction section 78 extracts facility information indicating a gas station located within a predetermined range from the present location of the mobile terminal 5 that transmitted the request information from the facility information management table 76.

The evaluation information extraction section 79 has the same function as the evaluation information extraction section 44 shown in FIG. 1. More specifically, the evaluation information extraction section 79 extracts evaluation information stored in the evaluation information management table 72 based on the gas station ID indicated by the facility information outputted from the facility information extraction section 78.

The user information management table 80 stores information on the user of the mobile terminal 5. The data structure of the user information management table 80 is the same as the data structure of the user information management table 39 shown in FIG. 6.

The evaluation information distribution section 81 has the same function as the evaluation information distribution section 45 shown in FIG. 1. More specifically, the evaluation information distribution section 81 distributes evaluation information extracted from the evaluation information extraction section 79 to the mobile terminal 5 that transmitted the request information.

The fuel information reception section 82 receives fuel information outputted from the fuel information transmission section 62. The fuel information reception section 82 outputs the received fuel information to the facility information extraction section 78 and the facility stay determination section 83.

Incidentally, while a case has been described above in which the request reception section 77 receives request information indicating a request for acquiring evaluation information from the mobile terminal 5 and the evaluation information distribution section 81 distributes evaluation information to the mobile terminal 5 that transmitted the request information, the evaluation information management apparatus 7 is not limited to this arrangement. For example, the evaluation information management apparatus 7 may be arranged so that, without receiving request information from the mobile terminal 5, the evaluation information distribution section 81 distributes evaluation information to the mobile terminal 5 based on mobile terminal location information stored in the location information management table 74.

In addition, it is also possible to have the evaluation information distribution section 81 distribute evaluation information to the mobile terminal 5 mounted on the mobile unit C when the remaining fuel detection section K detects that the fuel of the mobile unit C has dropped to or below a predetermined value. More specifically, when fuel information outputted from the fuel information reception section 82 indicates that the gasoline of the mobile unit C has dropped to or below a predetermined value, the facility information extraction section 78 extracts facility information indicating a gas station located within a predetermined range from the present location of the mobile terminal indicated by mobile terminal location information included in the fuel information from the facility information management table 76. The evaluation information extraction section 79 extracts evaluation information stored in the evaluation information management table 72 based on the facility information extracted by the facility information extraction section 78. The evaluation information distribution section 81 distributes evaluation information extracted by the evaluation information extraction section 79 to the mobile terminal 5. Accordingly, when the fuel of the mobile unit C drops to or below a predetermined value, the evaluation information distribution section 81 will be able to distribute evaluation information on a gas station located within a predetermined range from the present location of the mobile terminal 5 mounted on the mobile unit C.

### (Configuration of Evaluation Information Management Apparatus for Notifying User Information to Facility Computer)

In the same manner as the evaluation information management apparatus 3 shown in FIG. 1, the evaluation information management apparatus 7 further includes a function for notifying a facility computer 6 of information on the user of the mobile terminal 5 that provided evaluation information in the event that the user is staying at a gas station that is an object of evaluation information distributed from the evaluation information distribution section 81 to the mobile terminal 5. To this end, the evaluation information management apparatus 7 further includes a facility stay determination section 83 and a notification section 84.

The facility stay determination section 83 determines whether the user of the mobile terminal 5 is staying at the gas station that is an object of evaluation information distributed from the evaluation information distribution section 81 to the mobile terminal 5. More specifically, when the remaining fuel detection section K detects an increase in the gasoline of the mobile unit C on which is mounted the mobile terminal 5 to which evaluation information was distributed from the evaluation information distribution section 81, the facility stay determination section 83 determines that the user of the mobile terminal 5 is staying at the gas station indicated by the facility information extracted by the facility information extraction section 56.

The notification section 84 has the same function as the notification section 46 shown in FIG. 1. More specifically, when the facility stay determination section 83 determines that the user of the mobile terminal 5 is staying at a gas station, the notification section 84 notifies a facility computer 6 installed at the gas station of information on the user that provided the evaluation information. Consequently, the administrator of the gas station is able to return a portion of the profits of the gas station to the user that provided evaluation information. For example, to a user that has provided evaluation information, the administrator of the gas station may provide gasoline of the gas station at discount prices or grant privileges in the form of giveaways or the like.

Incidentally, the evaluation information management apparatus 7 described above may also be realized by installing a program in an arbitrary computer such as a personal computer. More specifically, the evaluation information reception section 71, the location information reception section 73, the location information updating section 75, the request reception section 77, the facility information extraction section 78, the evaluation information extraction section 79, the evaluation information distribution section 81, the fuel information reception section 82, the facility stay determination section 83 and the notification section 84 described above may be realized when a CPU of the computer operates in accordance with a program that realizes these functions. Therefore, a program for realizing the functions of the evaluation information reception section 71, the location information reception section 73, the location information updating section 75, the request reception section 77, the facility information extraction section 78, the evaluation information extraction section 79, the evaluation information distribution section 81, the fuel information reception section 82, the facility stay determination section 83 and the notification section 84, as well as a storage medium storing the program, also constitute an embodiment of the present invention. Furthermore, the evaluation information management table 72, the location information management table 74, the facility information management table 76 and the user information management table 80 may be realized by an internal storage device of the computer or a storage device accessible from the computer.

The respective components 71 to 84 that constitute the evaluation information management apparatus 7 described above may be configured by integrating the components into a single apparatus or may be configured by distributing the components into a plurality of apparatuses.

### (Example of Operation of Evaluation Information Distribution System)

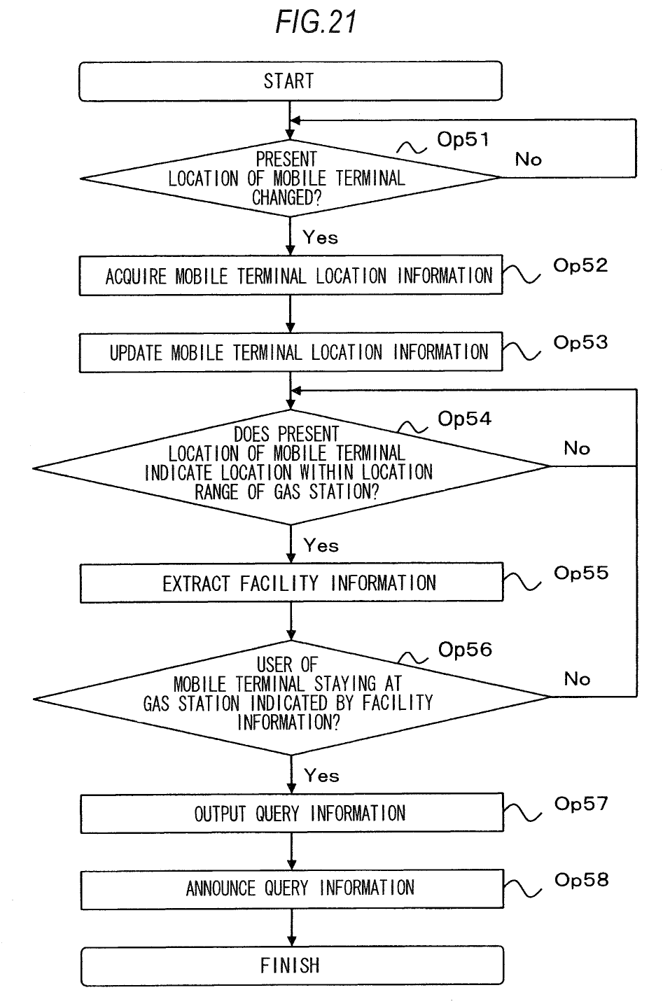

Next, processing performed by the evaluation information distribution system 10 according to the above configuration will be described with reference to FIG. 21.

FIG. 21 is a flowchart showing an outline of processing for announcing query information to the user of the mobile terminal 5. As shown in FIG. 21, when the present location of the mobile terminal 5 changes (YES in operation Op51), the present location measurement section 51 outputs mobile terminal location information indicating the present location of the mobile terminal 5 to the location information updating section 54. The location information updating section 54 acquires the mobile terminal location information outputted from the present location measurement section 51 (operation Op52). On the other hand, if the present location of the mobile terminal 5 does not change (NO in operation Op51), the routine returns to operation Op51.

Then, the location information updating section 54 updates the mobile terminal location information stored in the location information management table 53 to the mobile terminal location information acquired in operation Op52 (operation Op53).

Next, when it is determined that the present location of the mobile terminal 5 indicated by the mobile terminal location information stored in the location information management table 53 indicates a location within the location range of the gas station indicated by the facility location information stored in the facility information management table 55 (YES in operation Op54), the facility information extraction section 56 extracts facility information indicating this gas station from the facility information management table 55 (operation Op55). On the other hand, if it is determined that the present location of the mobile terminal 5 does not indicate a location within the location range of the gas station (NO in operation Op54), the facility information extraction section 56 returns to operation Op54.

The facility stay determination section 57 determines whether the user of the mobile terminal 5 is staying at the gas station indicated by the facility information extracted in operation Op55. More specifically, when the remaining fuel detection section K detects an increase in the gasoline of the mobile unit C, the facility stay determination section 57 determines that the user of the mobile terminal 5 is staying at the gas station indicated by the facility information extracted in operation Op55 (YES in operation Op56). In this case, the routine proceeds to operation Op57. On the other hand, when the remaining fuel detection section K does not detect an increase in the gasoline of the mobile unit C, the facility stay determination section 57 determines that the user of the mobile terminal 5 is not staying at the gas station indicated by the facility information extracted in operation Op55 (NO in operation Op56). In this case, the routine returns to operation Op54.

The inquiry section 58 outputs query information for inquiring the price of gasoline provided by the gas station to the annunciation section 59 (operation Op57). The annunciation section 59 announces query information outputted in operation Op57 (operation Op58).

Since the processing for transmitting evaluation information from the mobile terminal 5 to the evaluation information management apparatus 7, the processing for distributing evaluation information from the evaluation information management apparatus 7 to the mobile terminal 5, and the processing for notifying user information from the evaluation information management apparatus 7 to the facility computer 6 are the same as in the first embodiment, descriptions thereof will be omitted.

As seen, in the evaluation information distribution system 10 according to the present embodiment, the facility stay determination section 57 determines whether the user of the mobile terminal 5 is staying at the facility indicated by the facility information extracted by the facility information extraction section 56 based on information on the mobile unit C on which the mobile terminal 5 is mounted. In this case, information on the mobile unit C is, for instance, information indicating the remaining gasoline of the mobile unit C. Accordingly, when the facility stay determination section 57 determines that the user is not staying at the facility, the inquiry section 58 does not output query information for inquiring for an evaluation on the facility to the user of the mobile terminal 5. On the other hand, when the facility stay determination section 57 determines that the user is staying at the facility, the inquiry section 58 outputs query information for inquiring for an evaluation on the facility to the user of the mobile terminal 5. Therefore, in the event that the user of the mobile terminal 5 is staying at the facility, the evaluation information distribution system 10 according to the present embodiment is able to output query information for inquiring for an evaluation on the facility to the user of the mobile terminal 5.

For the first embodiment, an example has been described in which a facility stay determination section determines that a user of a mobile terminal is staying at a facility indicated by facility information in the event that the present location of the mobile terminal indicated by mobile terminal location information indicates a location within a location range of the facility indicated by facility location information over a period of time equal to or exceeding a stay determination time. Furthermore, for the second embodiment, an example has been described in which a facility stay determination section determines that a user of a mobile terminal is staying at a gas station indicated by facility information in the event that a remaining fuel detection section detects an increase in the gasoline of a mobile unit. However, the present invention is not limited to these modes. For instance, in a case where a user of a mobile terminal makes a payment for merchandise or the like using the mobile terminal, the facility stay determination section may be arranged to determine that the user of the mobile terminal is staying at a facility indicated by facility information based on the payment information (information from the mobile terminal).

In addition, while examples have been described for the first and second embodiments in which the respective tables store information in tabular format, the present invention is not limited to this arrangement. In other words, any storage format may be used.

Moreover, while examples have been described for the first and second embodiments in which a mobile terminal, an evaluation information management apparatus, and a facility computer are connected to each other via the Internet, the present invention is not limited to this arrangement. For instance, a mobile terminal, an evaluation information management apparatus, and a facility computer may be mutually accessible via wireless communication.

The present invention is not limited to the first and second embodiments described above, and various modifications may be made within the scope of the following claims. In other words, it is to be understood that embodiments realized by combining technical means appropriately altered within the scope of the following claims are also embraced by the technical scope of the present invention.

As described above, the information communication system, the information communication method, and the program according to the present invention enables output of query information for inquiring for an evaluation of the facility to a user of a mobile terminal in a case where the user of the mobile terminal is staying at the facility.

What is claimed is:

1. An information communication system comprising:
a location information acquisition part which acquires mobile terminal location information indicating a present location of a mobile terminal;
a location information storage part which stores the mobile terminal location information;
a location information updating part which updates mobile terminal location information stored in the location information storage part with mobile terminal location information acquired by the location information acquisition part;
a facility information storage part which stores facility information identifying a facility and facility location information indicating a location range of the facility;
a facility information extraction part which, in the event that the present location of the mobile terminal indicated by the mobile terminal location information indicates a location within the location range of a facility indicated by the facility location information, extracts facility information indicating the facility in the facility information storage part;
a facility stay determination part which determines whether a user of the mobile terminal is staying at the facility indicated by the facility information extracted by the facility information extraction part based on information on the mobile terminal or information on a mobile unit on which the mobile terminal is mounted; and
an inquiry part which outputs query information for inquiring for an evaluation of the facility to the user of the mobile terminal when the facility stay determination part determines that the user of the mobile terminal is staying at the facility.

2. The information communication system according to claim 1, further comprising:
a stay determination time storage part which stores a stay determination time indicating a threshold of whether a user of the mobile terminal is staying at the facility indicated by the facility information extracted by the facility information extraction part, wherein
the facility stay determination part determines that the user of the mobile terminal is staying at the facility indicated by the facility information extracted by the facility information extraction part when the present location of the mobile terminal indicated by the mobile terminal location information indicates a location within a location range of the facility indicated by the facility location information over a period of time equal to or exceeding the stay determination time.

3. The information communication system according to claim 2, wherein
the stay determination time storage part stores stay determination times respectively, corresponding to each facility or each facility type.

4. The information communication system according to claim 1, wherein
the inquiry part outputs query information with different contents corresponding to each facility or each facility type to the user of the mobile terminal.

5. The information communication system according to claim 1, wherein
the mobile terminal is mountable on a mobile unit that travels while consuming power from a power source,
the facility is a power source providing location that provides the power source to the mobile unit,
the facility stay determination part determines that the user of the mobile terminal is staying at the facility indicated by facility information extracted by the facility information extraction part when the power source of the mobile unit increases, and
the inquiry part outputs query information for inquiring about the price of the power source provided by the facility to the user of the mobile terminal when the facility stay determination part determines that a user of the mobile terminal is staying at the facility.

6. The information communication system according to claim 1, further comprising:
an evaluation information storage part which stores facility information identifying a facility and evaluation information indicating an evaluation of the facility which is obtained as a response to the inquiry;
a request reception part which receives, from the mobile terminal, request information indicating a request for acquiring the evaluation information;
an evaluation information extraction part which extracts evaluation information stored in the evaluation information storage part based on facility information extracted by the facility information extraction part from the facility information storage part and which indicates a facility located within a predetermined range from the present location of the mobile terminal that transmitted the request information; and
an evaluation information distribution part which distributes evaluation information extracted by the evaluation information extraction part to the mobile terminal that transmitted the request information.

7. The information communication system according to claim 1, further comprising:
an evaluation information storage part which stores facility information identifying a facility and evaluation information indicating an evaluation of the facility which is obtained as a response to the inquiry;
an evaluation information extraction part which extracts evaluation information stored in the evaluation information storage part based on facility information extracted by the facility information extraction part from the facility information storage part and which indicates a facility located within a predetermined range from the present location of the mobile terminal indicated by mobile terminal location information stored in the location information storage part; and
an evaluation information distribution part which distributes evaluation information extracted by the evaluation information extraction part to the mobile terminal indicated by mobile terminal location information stored in the location information storage part.

8. The information communication system according to claim 5, further comprising:
an evaluation information storage part which stores facility information identifying a facility and evaluation information indicating an evaluation of the facility which is obtained as a response to the inquiry;
an evaluation information extraction part which extracts evaluation information stored in the evaluation information storage part based on facility information extracted by the facility information extraction part from the facility information storage part and which indicates a facility located within a predetermined range from the present location of a mobile terminal mounted on the mobile unit when the power source of the mobile unit drops to or below a predetermined value; and
an evaluation information distribution part which distributes evaluation information extracted by the evaluation information extraction part to the mobile terminal mounted on the mobile unit.

9. The information communication system according to claim 6, further comprising:
a notification part which notifies a facility computer installed at a facility that is an object of evaluation information distributed by the evaluation information distribution part to the mobile terminal of information on a user that provided the evaluation information in the event that the facility stay determination part, which further determines whether the user of the mobile terminal is staying at the facility and determines that the user of the mobile terminal is staying at the facility.

10. An information communication method executed by a computer comprising: a location information storage part which stores mobile terminal location information indicating a present location of a mobile terminal; and a facility information storage part which stores facility information identifying a facility and facility location information indicating a location range of the facility, the information communication method comprising:
a location information acquisition step for acquiring mobile terminal location information indicating a present location of a mobile terminal;
a location information updating step for updating mobile terminal location information stored in the location information storage part to mobile terminal location information acquired in the location information acquisition step;
a facility information extraction step for extracting facility information indicating a facility from the facility information storage part in the event that the present location of the mobile terminal indicated by the mobile terminal location information indicates a location within a location range of the facility indicated by the facility location information;
a facility stay determination step for determining whether a user of the mobile terminal is staying at the facility indicated by the facility information extracted in the facility information extraction step based on information on the mobile terminal or information on a mobile unit on which the mobile terminal is mounted; and
an inquiry step for outputting query information to inquire for an evaluation of the facility to the user of the mobile terminal when it is determined in the facility stay determination step that the user of the mobile terminal is staying at the facility.

11. A storage medium storing a program for causing a computer to execute processing of receiving or transmitting information, the computer comprising: a location information storage part which stores mobile terminal location information indicating a present location of a mobile terminal; and a facility information storage part which stores facility information identifying a facility and facility location information indicating a location range of the facility, the program causing the computer to execute:
location information acquisition processing for acquiring mobile terminal location information indicating a present location of a mobile terminal;
location information updating processing for updating mobile terminal location information stored in the location information storage part to mobile terminal location information acquired through the location information acquisition processing;
facility information extraction processing for extracting facility information indicating a facility from the facility information storage part in the event that the present location of the mobile terminal indicated by the mobile terminal location information indicates a location within a location range of the facility indicated by the facility location information;
facility stay determination processing for determining whether a user of the mobile terminal is staying at the facility indicated by the facility information extracted through the facility information extraction processing based on information on the mobile terminal or information on a mobile unit on which the mobile terminal is mounted; and
inquiry processing for outputting query information for inquiring for an evaluation of the facility to the user of the mobile terminal when it is determined through the facility stay determination processing that the user of the mobile terminal is staying at the facility.

12. A mobile unit including a mobile terminal provided with the information communication system according to any one of the claims 1 to 5.
